(19) United States
(12) Patent Application Publication
(10) Pub. No.: US 2019/0283435 A1
(43) Pub. Date: Sep. 19, 2019

(54) HEAD MODULE, INKJET RECORDER, AND METHOD OF ADJUSTING POSITION OF INKJET HEAD

(71) Applicant: Konica Minolta, Inc., Tokyo (JP)

(72) Inventor: Takeshi URAKAMI, Tokyo (JP)

(21) Appl. No.: 16/353,280

(22) Filed: Mar. 14, 2019

(30) Foreign Application Priority Data
Mar. 16, 2018 (JP) 2018-050209

(51) Int. Cl. B41J 2/175

(52) U.S. Cl. CPC B41J 2/1752

(57) ABSTRACT

Ahead module includes: an inkjet head that ejects ink; and a mounting member on which the inkjet head is mounted, wherein the inkjet head is mounted on the mounting member by being pressed against the mounting member by a presser, and a mounting position to the mounting member is adjusted by a position adjuster in a direction intersecting with a pressing direction of the presser.

### CROSS REFERENCE TO RELATED APPLICATION

The present application claims priority under 35 U.S.C. § 119 to Japanese patent Application No. 2018-050209, filed on Mar. 16, 2018, is incorporated herein by reference in its entirety.

### BACKGROUND

### Technological Field

The present invention relates to a head module, an inkjet recorder, and a method of adjusting a position of an inkjet head, and more particularly, to a head module, an inkjet recorder, and a method of adjusting a position of an inkjet head that enable easy and reliable positional adjustment of the inkjet head.

### Description of the Related Art

An inkjet recorder includes an inkjet head that ejects ink droplets toward a recording medium. There are proposed head modules in which a plurality of inkjet heads is mounted on a common mounting member (carriage) to form a unit, and the number and density of ejecting nozzles that eject ink are increased (JP 2013-202930 A and JP 2000-263768 A).

In these head modules, an ink ejection surface (bottom surface) of the inkjet head is mounted on a mounting surface (upper surface) of the mounting member, which is flat. A through hole corresponding to the ink ejection surface of the inkjet head is formed in the mounting member, and the ink ejection surface of the inkjet head faces a recording medium through the through hole. A peripheral part of the ink ejection surface of the inkjet head is screwed to a peripheral part of the through hole of the mounting member.

The position of the inkjet head with respect to the mounting member is determined by inserting two reference pins (positioning pins) into two reference holes (positioning holes). The reference pins are provided on the side of the ink ejection surface of the inkjet head. The reference holes are provided in the mounting member. The two reference pins are provided one by one on each of both end sides of the ink ejection surface in a longitudinal direction (arrangement direction of the ejecting nozzles). The two reference holes are provided at positions corresponding to the two reference pins. The one reference hole is a round hole. The other reference hole is a long hole that has a major axis in the longitudinal direction of the ink ejection surface.

The one reference pin is inserted into the one reference hole (round hole). A side surface part of the reference pin is pressed against an inner peripheral surface of the reference hole in a predetermined direction. This operation determines the position of the reference pin in the mounting surface. The one reference pin and the one reference hole (round hole) do not determine the position in a rotational direction around an axis of the reference pin. The position in the rotational direction around the axis of the one reference pin is determined by inserting the other reference pin into the other reference hole (long hole). A side surface part of the other reference pin is pressed against an inner peripheral surface of the other reference hole (long hole) in a predetermined direction. This operation determines the position in the rotational direction around the axis of the one reference pin. The positional adjustment of the inkjet head is completed.

When the inkjet head positionally adjusted as described above is fixed to the mounting member by tightening a screw, a screw seat is brought into contact with the inkjet head, and rotational force of the screw may be transmitted to the inkjet head to rotate (positionally displace) the inkjet head. When such rotation (positional displacement) occurs, the position of the inkjet head needs to be readjusted while the screw is loosened, which is complicated.

In addition, there is need for the position of the inkjet head to be preliminarily adjusted to a position different from a target position, and brought to the target position after the screw is tightened, on the assumption of such rotation (positional displacement). When an assumed amount of movement due to the screw tightening deviates from an actual amount of movement due to the screw tightening, however, the position of the inkjet head needs to be readjusted while the screw is loosened, which is complicated.

### SUMMARY

It is therefore an object of the invention to provide a head module, an inkjet recorder, and a method of adjusting a position of an inkjet head that enable easy and reliable positional adjustment of the inkjet head.

Furthermore, the following description will reveal an additional object of the invention.

To achieve the abovementioned object, according to an aspect of the present invention, a head module reflecting one aspect of the present invention comprises:

an inkjet head that ejects ink; and

a mounting member on which the inkjet head is mounted,

wherein the inkjet head is mounted on the mounting member by being pressed against the mounting member by a presser, and a mounting position to the mounting member is adjusted by a position adjuster in a direction intersecting with a pressing direction of the presser.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a perspective view of a head module according to an embodiment;

FIG. 2 is a perspective view of an inkjet head of the head module as seen from the bottom side;

FIG. 3 is a bottom view of the inkjet head;

FIG. 4 is a side view of the inkjet head;

FIG. 5 is a perspective view of a main part of a mounting member (carriage) of the head module;

FIG. 6A is a plan view of a reference surface to which a reference pin is pressed in the head module;

FIG. 6B is a plan view of another exemplary reference surface;

FIG. 7 is a perspective view of the main part of the mounting member (carriage);

FIG. 8 is a perspective view of a main part of the head module;

FIG. 9 is a perspective view of a presser of the head module;

FIG. 10 is a perspective view of a main part of a position adjuster of the head module;

FIG. 11 is a plan view of the position adjuster;

FIG. 12 is a perspective view of an adjusting screw of the position adjuster;

FIG. 13 is a plan view illustrating an adjustment procedure with the position adjuster; and

FIG. 14 is a block diagram of an inkjet recorder.

### DETAILED DESCRIPTION OF EMBODIMENTS

Hereinafter, a head module, an inkjet recorder, and a method of adjusting a position of an inkjet head according to one or more embodiments of the present invention will be described with reference to the drawings. However, the scope of the invention is not limited to the disclosed embodiments. In the following description, components having the same functions and configurations are denoted by the same signs, and descriptions thereof may be omitted.

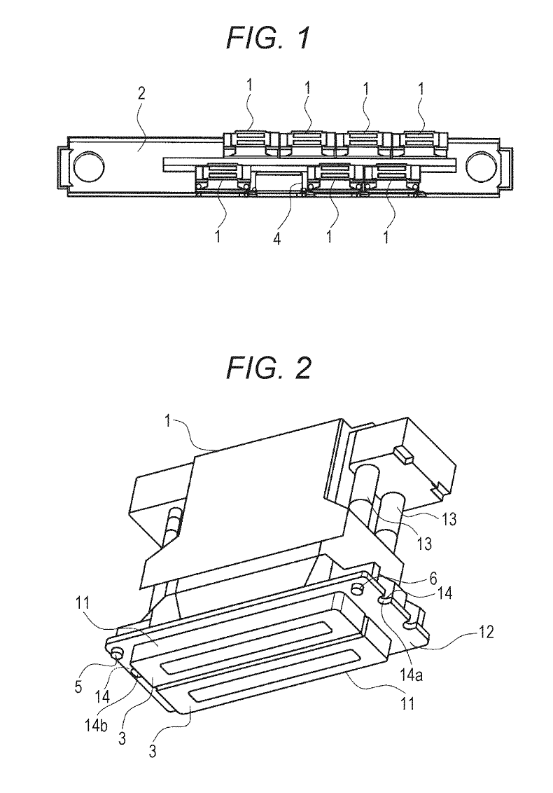

FIG. 1 is a perspective view of a head module according to an embodiment.

As illustrated in FIG. 1, the head module according to the embodiment includes a plurality of inkjet heads 1 and a flat mounting member (carriage) 2. The plurality of inkjet heads 1 is positionally adjusted (positioned) to be mounted or placed on the mounting member 2. The mounting member 2 is formed of a metal plate. In the embodiment, eight inkjet heads 1 are mounted to the mounting member 2. A method of adjusting a position of an inkjet head in the embodiment is practiced in a process of adjusting the position of the inkjet head 1 in the head module.

FIG. 2 is a perspective view of the inkjet head of the head module as seen from the bottom side.

As illustrated in FIG. 1 and FIG. 2, an ink ejection surface (bottom surface) 3 of each inkjet head 1 is mounted on a mounting surface (upper surface) of the mounting member 2 in the head module. A through hole 4 corresponding to the ink ejection surface 3 of each inkjet head 1 is formed in the mounting member 2. The ink ejection surface 3 of each inkjet head 1 faces a recording medium through the through hole 4. A peripheral part of the ink ejection surface 3 of the inkjet head 1 is mounted to a peripheral part of the through hole 4 of the mounting member 2.

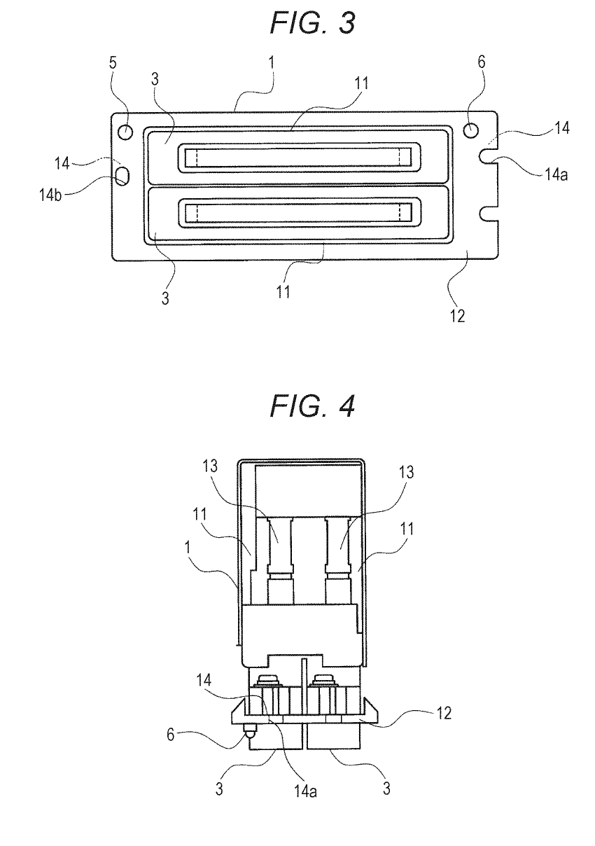

FIG. 3 is a bottom view of the inkjet head.

FIG. 4 is a side view of the inkjet head.

In the embodiment, as illustrated in FIG. 3 and FIG. 4, the inkjet head 1 includes a plurality of head bodies 11 and a holder 12 for holding each head body 11. The plurality of (two in the embodiment) head bodies 11 are held in one holder 12.

Ink channels 13 are provided on the holder 12. The ink channel 13 supplies ink supplied from outside to the head body 11. The head body 11 has an ejecting-nozzle array on the ink ejection surface 3. Nozzle openings communicating with the ink channels 13 are arranged side by side to form the ejecting-nozzle array. The number of the ejecting-nozzle array is not particularly limited, and one or a plurality of ejecting-nozzle arrays may be provided.

An ejector (not illustrated) for ejecting ink from the nozzle opening is provided inside the head body 11. The ejector is not particularly limited, and may include, for example, an ejector that ejects ink by applying pressure on the ink with a piezoelectric or heating element, an ejector that ejects ink by deforming a diaphragm by electrostatic force, an ejector that ejects ink by an electrostatic ejection method, and an ejector of any other method.

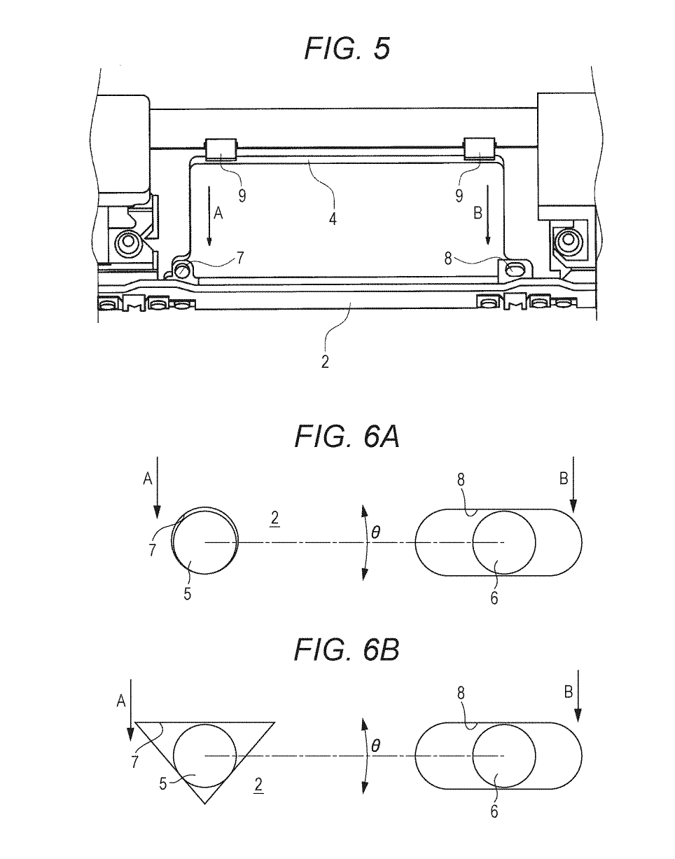

FIG. 5 is a perspective view of a main part of the mounting member (carriage) of the head module.

FIG. 6A is a plan view of a reference surface to which the reference pin is pressed in the head module. FIG. 6B is a plan view of another exemplary reference surface.

As illustrated in FIG. 2, FIG. 5, and FIG. 6A, the position of the inkjet head 1 with respect to the mounting member 2 is adjusted by inserting two reference pins (positioning pins) 5 and 6 into two reference holes (positioning holes) 7 and 8. The reference pins 5 and 6 are provided on the side of the ink ejection surface 3 of the inkjet head 1. The reference holes 7 and 8 are provided in the mounting member 2. The two reference pins 5 and 6 are provided one by one on each of both end sides of the ink ejection surface 3 in a longitudinal direction (arrangement direction of the ejecting nozzles). The two reference holes 7 and 8 are provided at positions corresponding to the two reference pins. The one reference hole 7 is a round hole. The other reference hole 8 is a long hole that has a major axis in the longitudinal direction of the ink ejection surface.

The one reference pin 5 is inserted into the one reference hole (round hole) 7. A side surface part of the reference pin 5 is pressed against an inner peripheral surface, which serves as the reference surface, in a predetermined direction of the reference hole 7 in a predetermined direction indicated by arrows A in FIG. 5, FIG. 6A, and FIG. 6B. This operation determines the position of the reference pin 5 in the mounting surface.

Consequently, the one reference hole 7 is not limited to the round hole, and required to have any shape in which the position of the axis of the reference pin 5 is determined by pressing the side surface of the reference pin 5. As illustrated in FIG. 6B, the one reference hole 7 may be a V-groove or a polygonal hole. The V-groove or the polygonal hole is to be abutted on two parts of the side surface of the pressed reference pin 5.

Note that, in the case where the inkjet head 1 ejects heated ink, the thermal expansion coefficient of a material constituting the reference pin 5 is preferably equal to or greater than that of a material of the mounting member 2 constituting the reference surface. The is to prevent a gap from being generated between the reference pin 5 and the reference surface when the reference pin 5 and the reference surface are also heated (usage state) by the heated ink.

The one reference pin 5 and the one reference hole (round hole) 7 do not determine the position in a rotational direction around an axis of the reference pin 5. Arrows θ in FIG. 6A and FIG. 6B indicate the rotational direction. The position in the rotational direction around the axis of the one reference pin 5 is determined by inserting the other reference pin 6 into the other reference hole (long hole) 8. A side surface part of the other reference pin 6 is pressed against an inner peripheral surface of the other reference hole (long hole) 8 in a predetermined direction indicated by arrows B in FIG. 5, FIG. 6A, and FIG. 6B. This operation determines the position in the rotational direction around the axis of the one reference pin 5.

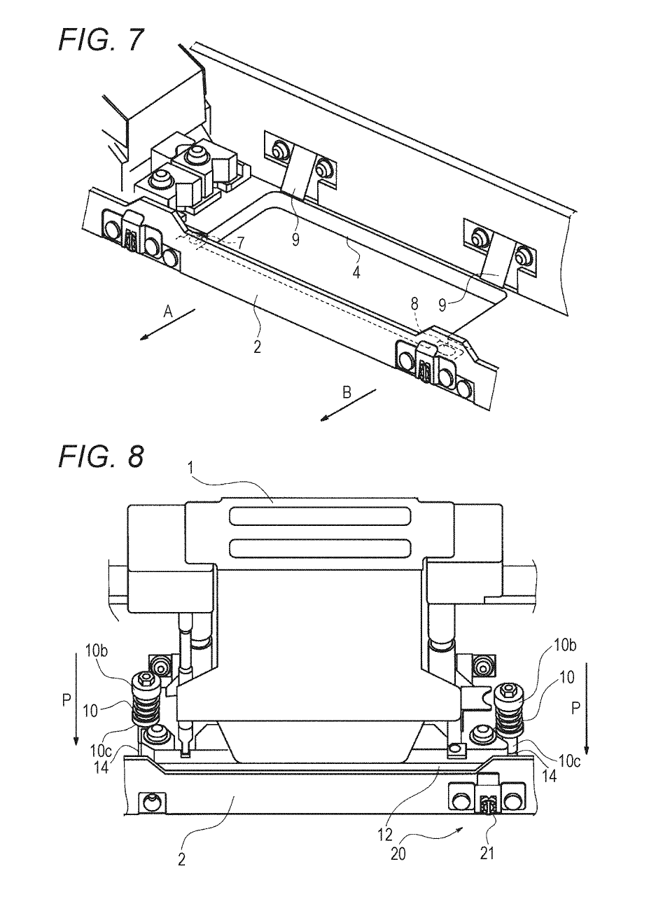

FIG. 7 is a perspective view of the main part of the mounting member (carriage).

As illustrated in FIG. 7, plate springs 9 and 9 are preferably provided on the mounting member 2. The plate springs 9 are elastic members that press the side surface part of the one reference pin 5 against the inner peripheral surface, which serves as the reference surface, in a predetermined direction of the reference hole 7. The plate springs 9 and 9 press the side surface part of the inkjet head 1 mounted to a predetermined position of the mounting member 2. The plate springs 9 press the side surface part of the one reference pin 5 against the inner peripheral surface, which serves as the reference surface, in a predetermined direction of the one reference hole 7 in a predetermined direction indicated by an arrow A in FIG. 7. In addition, the plate springs 9 press the side surface part of the other reference pin 6 against the inner peripheral surface of the other reference hole (long hole) 8 in a predetermined direction indicated by an arrow B in FIG. 7.

FIG. 8 is a perspective view of a main part of the head module.

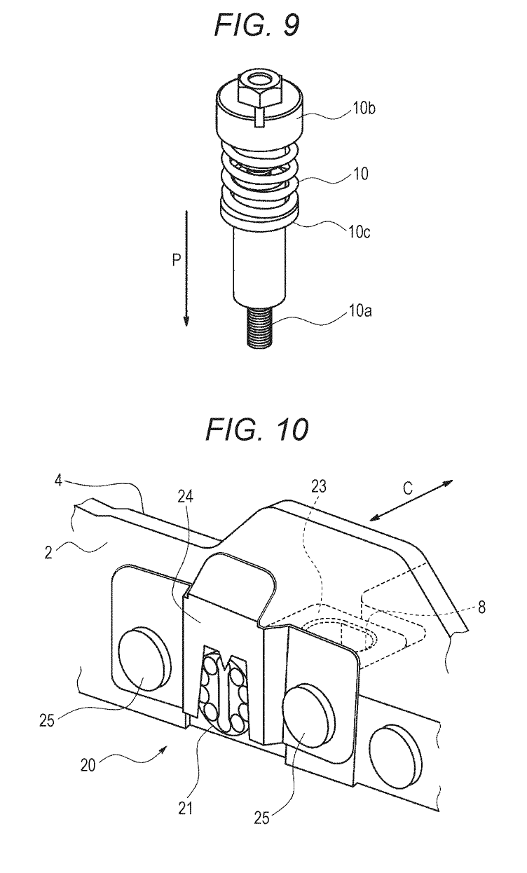

FIG. 9 is a perspective view of a presser of the head module.

In such a manner, the positions of the reference pins 5 and 6 are determined with respect to the reference holes 7 and 8. As illustrated in FIG. 8, the position of the inkjet head 1 is determined with respect to the mounting member 2. In the embodiment, the position of the inkjet head 1 is further adjusted as described later.

The inkjet head 1 is mounted on the mounting member 2 by being pressed against the mounting member 2 by the presser. As illustrated in FIG. 8, the presser is formed by a coil spring 10, which is an elastic body. The presser presses the inkjet head 1 against the mounting member 2 with certain pressing force caused by reaction force of the coil spring 10. As illustrated in FIG. 9, the coil spring 10 is externally fitted to a shaft screw 10a. The lower end side of the shaft screw 10a is screwed to (a screw hole of) the mounting surface (upper surface) of the mounting member 2. An upper flange member 10b is mounted on the upper end side of the shaft screw 10a. A lower flange member 10c is mounted on a middle part of the shaft screw 10a. The lower flange member 10c can slide on the shaft screw 10a in an axial direction. The upper and lower ends of the coil spring 10 are sandwiched between the upper and lower flange members 10b and 10c.

As illustrated in FIG. 8, when the lower end side of the shaft screw 10a is screwed into the mounting surface (upper surface) of the mounting member 2, the lower end part of the lower flange member 10c abuts on the holder 12 of the inkjet head 1. The coil springs 10 are provided one by one on each of both end sides of the ink ejection surface 3 in a longitudinal direction (arrangement direction of the ejecting nozzles). The lower end part of the lower flange member 10c abuts on a flange 14. The flanges 14 are at both sides of the holder 12 of the inkjet head 1. As illustrated in FIG. 2 to FIG. 4, the flange 14 corresponds to a peripheral edge part of a cutout part 14a or a through hole 14b. The shaft screw 10a is inserted through the cutout part 14a or the through hole 14b. When a screwing amount of the shaft screw 10a to the mounting member 2 is increased, the upper flange member 10b approaches the flange 14 of the inkjet head 1, so that the distance between the upper and lower flange members 10b and 10c is narrowed, and the coil spring 10 is compressed. Reaction force of the compressed coil spring 10 presses the inkjet head 1 against the mounting member 2 as indicated by arrows P in FIG. 8 and FIG. 9. When a compression amount of the coil spring 10 (screwing amount of the shaft screw 10a to the mounting member 2) is set to a predetermined amount, the pressing force of the inkjet head 1 against the mounting member 2 is constant. The pressing force is, for example, approximately 1 to 3 Kg·f.

FIG. 10 is a perspective view of a main part of a position adjuster of the head module.

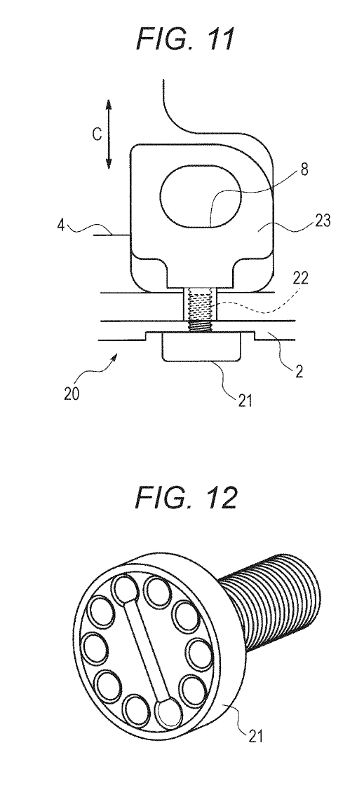

FIG. 11 is a plan view of the position adjuster.

FIG. 12 is a perspective view of an adjusting screw of the position adjuster.

As illustrated in FIG. 10, the mounting position of the inkjet head 1 to the mounting member 2 is adjusted by an adjusting screw 21 that applies external force in a direction indicated by an arrow C in FIG. 10. The adjusting screw 21 constitutes a position adjuster 20. The direction indicated by an arrow C intersects with the pressing direction of the coil spring 10.

Note that, the intersecting direction (arrow C in FIG. 10) corresponds to a direction that is not parallel to the pressing direction of the coil spring 10. In particular, the intersecting direction preferably corresponds to a direction that is substantially orthogonal (90°±20°) to the pressing direction.

As illustrated in FIG. 10 to FIG. 12, the position adjuster 20 includes an adjusting screw 21. The position adjuster 20 adjusts the position of the inkjet head 1 by advancing and retreating movement in the axial direction due to rotation of the adjusting screw 21. Note that a plurality of mark holes 21a for easy recognition of a rotation amount of the screw is provided on the head of the adjusting screw 21.

Note that the pressing force of the inkjet head 1 against the mounting member 2 caused by the coil spring 10 is preferably in a range where positional adjustment of the inkjet head 1 with the position adjuster 20 is not inhibited. In the case, the position of the inkjet head 1 can be adjusted by the position adjuster 20 without loosening the shaft screw 10a.

As illustrated in FIG. 11, the adjusting screw 21 is placed so as to penetrate through the front part of the mounting member 2 into the through hole 4 in the position adjuster 20. The position adjuster 20 includes an adjusting plate 23. The adjusting plate 23 includes a screw part 22 screwed into the adjusting screw 21. The adjusting plate 23 is positioned at an end of the through hole 4. The other reference hole (long hole) 8 is provided in the adjusting plate 23.

As illustrated in FIG. 10, the adjusting screw 21 is held by a pressing plate spring 24 with the screw top pressed against the front part of the mounting member 2. The pressing plate spring 24 is mounted to the front part of the mounting member 2 by screws 25 and 25.

In the position adjuster 20, the rotation of the adjusting screw 21 causes the adjusting plate 23 to advance and retreat in the axial direction of the adjusting screw 21 as indicated by arrows C in FIG. 10 and FIG. 11. The advancing and retreating movement of the adjusting plate 23 causes the position of the inkjet head 1 to be adjusted in the rotational direction around the axis of the one reference pin 5. In the inkjet head 1, the other reference pin 6 is inserted into the other reference hole (long hole) 8. Note that the adjusting screw 21 may be automatically rotated by a driving source such as a motor, or may be manually rotated with a tool such as a driver.

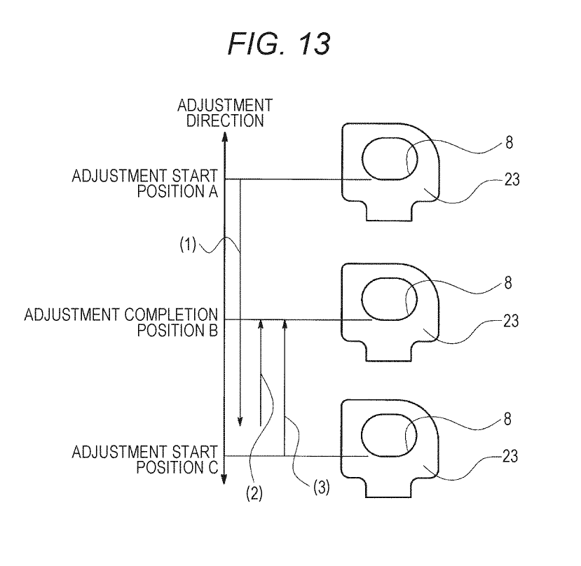

FIG. 13 is a plan view illustrating an adjustment procedure with the position adjuster.

As illustrated in FIG. 13, in the adjustment procedure with the position adjuster 20, the adjustment is preferably completed by rotating the adjusting screw 21 in predetermined one direction and stopping the adjusting screw 21 in order to eliminate backlash between a screw groove of the adjusting screw 21 and a screw of the adjusting plate 23. That is, when the adjusting plate 23 is adjusted from an adjustment start position A to an adjustment completion position B (adjusted downward in FIG. 13), the adjusting plate 23 is once moved from the adjustment start position A to a position beyond the adjustment completion position B (arrow (1) in FIG. 13), and then the adjusting plate 23 is returned to the adjustment completion position B (arrow (2) in FIG. 13). In such a way, the adjustment is completed. In addition, when the adjusting plate 23 is adjusted from an adjustment start position C to the adjustment completion position B (adjusted upward in FIG. 13), the adjusting plate 23 is moved from the adjustment start position C to the adjustment completion position B (arrow (3) in FIG. 13) to complete the adjustment. In these cases, the rotational direction of the adjusting screw 21 at the completion of the adjustment is determined in the direction from the adjustment start position C to the adjustment completion position B (upward in FIG. 13). Adoption of such an adjustment procedure can eliminates the backlash.

In the head module, the position of the inkjet head 1 can be adjusted without loosening the shaft screw 10a that presses the coil spring 10. In contrast to the traditional configuration in which the inkjet head 1 is fixed by tightening a screw, there is no risk of rotation (positional displacement) of the inkjet head 1. When a screw seat is brought into contact with the inkjet head 1, rotational force of the screw is transmitted to the inkjet head 1 to rotate the inkjet head 1. In addition, there is no need of consideration for the position of the inkjet head 1 to be preliminarily adjusted to a position different from a target position, and brought to the target position after the screw is tightened, on the assumption of such rotation (positional displacement). Consequently, the head module needs no readjustment after the completion of the positional adjustment of the inkjet head 1, and needs no adjustment to the position different from the target position. The position of the inkjet head 1 can be kept easily, reliably, and stably. Such positional adjustment of the inkjet head 1 can be easily and reliably performed in the above-described procedure not only before shipping of the head module from a factory but also when the inkjet head 1 is positionally displaced during use of the head module.

In the head module, the plate springs 9 and 9 constantly impart pressing force to the inkjet head 1, so that the reference pins 5 and 6 are not moved with respect to the reference holes 7 and 8, and the behavior of the inkjet head 1 can be stabilized during thermal expansion. In the case where an image resolution in printing with the inkjet head 1 is high, for example, 1200 dpi, the distance between adjacent dots is 21 μm. In the head module, the gap between the reference holes 7 and 8 and the reference pins 5 and 6 can be smaller enough than 21 μm, smaller enough to be negligible.

Note that tools such as a jig may apply external force for adjusting the position of the inkjet head 1 to the inkjet head 1.

In the case where the inkjet head 1 ejects heated ink, the position of the inkjet head 1 is preferably adjusted with the reference pin 5 and the reference surface heated as in the assumed usage state. The is to prevent a gap from being generated between the reference pin 5 and the reference surface in the usage state.

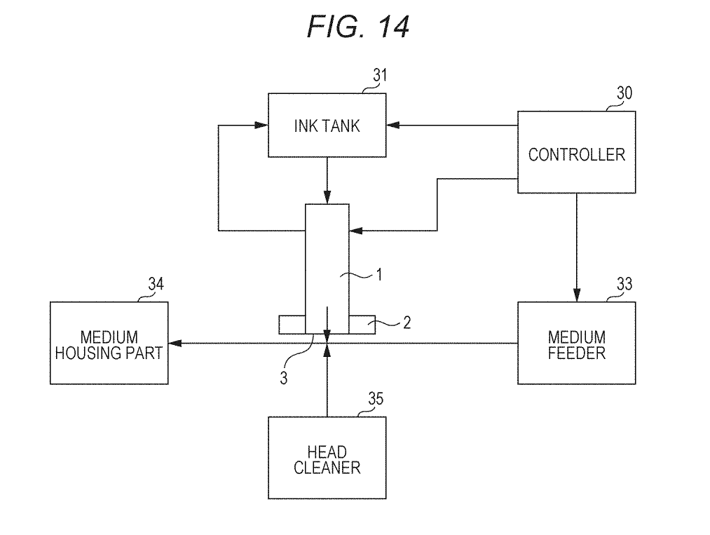

FIG. 14 is a block diagram of the inkjet recorder.

The head module configured in such a way can constitute the inkjet recorder. As illustrated in FIG. 14, the inkjet recorder includes a controller 30 for controlling the inkjet head 1. The controller 30 also controls a medium feeder 33 for feeding a recording medium to a printing position of the inkjet head 1. The recording medium includes paper, synthetic resin, and cloth. The recording medium fed by the medium feeder 33 is housed in a medium housing part 34 via the printing position.

In the inkjet recorder, ink stored in an ink tank 31 is supplied to the inkjet head 1 under the control of the controller 30. Moreover, the medium feeder 33 feeds the recording medium to the printing position under the control of the controller 30. The inkjet head 1 performs printing by ejecting the ink onto the recording medium at the printing position under the control of the controller 30. The ink that is not used in the inkjet head 1 is returned to the ink tank 31. The printed recording medium is housed in the medium housing part 34.

In the inkjet head 1, ink or dust attached on the ink ejection surface 3 may cause nozzle clogging, and thus the ink ejection surface 3 may require to be cleaned. Consequently, the inkjet recorder provided with the head module may include a head cleaner 35. The head cleaner 35 cleans the ink ejection surface 3 by pressing a cleaning member against the ink ejection surface 3 of the inkjet head 1. The cleaning member is formed of, for example, cloth, a roller, or a silicon plate. In the case, the force with which the cleaning member presses the ink ejection surface 3 is preferably smaller than the pressing force of the inkjet head 1 against the mounting member 2 caused by the coil spring 10. This is to prevent the inkjet head 1 from being positionally displaced by the force with which the cleaning member presses the ink ejection surface 3 during cleaning of the ink ejection surface 3.

Although embodiments of the present invention have been described and illustrated in detail, the disclosed embodiments are made for purposes of illustration and example only and not limitation. The scope of the present invention should be interpreted by terms of the appended claims, and contains all modifications within the meaning and range equivalent to the claims.

What is claimed is:

1. A head module comprising:
an inkjet head that ejects ink; and
a mounting member on which the inkjet head is mounted,
wherein the inkjet head is mounted on the mounting member by being pressed against the mounting member by a presser, and a mounting position to the mounting member is adjusted by a position adjuster in a direction intersecting with a pressing direction of the presser.

2. The head module according to claim 1, wherein the presser is formed by an elastic body, and presses the inkjet head against the mounting member with certain pressing force caused by reaction force of the elastic body.

3. The head module according to claim 1, wherein the pressing force of the inkjet head against the mounting member caused by the presser is in a range where positional adjustment of the inkjet head with the position adjuster is not inhibited.

4. The head module according to claim 1, wherein the position adjuster includes an adjusting screw, and adjusts a position of the inkjet head by advancing and retreating movement in an axial direction due to rotation of the adjusting screw.

5. The head module according to claim 1, further comprising:
a reference pin that is erected on the inkjet head, and faces the mounting member;
a reference surface that is provided on the mounting member, and determines a position of the reference pin by being brought into contact with a side surface part of the reference pin; and
an elastic member that presses the side surface part of the reference pin against the reference surface,
wherein the position adjuster adjusts a position of the inkjet head in a rotational direction around an axis of the reference pin.

6. The head module according to claim 5,
wherein the inkjet head ejects heated ink, and
a thermal expansion coefficient of a material constituting the reference pin is equal to or greater than that of a material constituting the reference surface.

7. An inkjet recorder comprising the head module according to claim 1.

8. The inkjet recorder according to claim 7, further comprising a head cleaner that cleans an ink ejection surface by pressing a cleaning member against the ink ejection surface of the inkjet head,
wherein force with which the cleaning member presses the ink ejection surface is smaller than pressing force of the inkjet head against the mounting member caused by the presser.

9. A method of adjusting a position of an inkjet head, comprising:
placing an inkjet head that ejects ink on a mounting member;
pressing the inkjet head against the mounting member with a presser; and
applying external force to the inkjet head, moving the inkjet head in a direction intersecting with a pressing direction of the presser, and adjusting a mounting position of the inkjet head with respect to the mounting member.

10. The method of adjusting a position of an inkjet head, according to claim 9, wherein the external force is applied by advancing and retreating movement in an axial direction due to rotation of an adjusting screw provided in the mounting member.

11. The method of adjusting a position of an inkjet head, according to claim 10, wherein the adjusting a mounting position of the inkjet head with respect to the mounting member is completed by rotating the adjusting screw in predetermined one direction and stopping the adjusting screw.
